(19) United States
(12) Patent Application Publication
(10) Pub. No.: US 2019/0195258 A1
(43) Pub. Date: Jun. 27, 2019

(54) SELF-SECURING BOLT-RETAINING DEVICE

(71) Applicants: Martin Zimmer, Rheinau (DE); Günther Zimmer, Rheinau (DE)

(72) Inventors: Martin Zimmer, Rheinau (DE); Günther Zimmer, Rheinau (DE)

(21) Appl. No.: 16/313,915

(22) PCT Filed: Jun. 28, 2017
(86) PCT No.: PCT/DE2017/000187

§ 371 Date: Mar. 4, 2019

(30) Foreign Application Priority Data
Jun. 29, 2016 (DE) 10 2016 007 871.5

(51) Int. Cl. F16B 13/08; F16B 13/12; F16B 12/24; F16B 41/00

(52) U.S. Cl. CPC F16B 13/0858; F16B 13/126; A47B 2230/0051; F16B 41/002; A47B 2230/0037; F16B 12/24

(57) ABSTRACT

A bolt-retaining device has a cylindrical device enveloping contour, a diameter of which is greater than a nominal diameter of the bolt-retaining device. It includes a retaining section and a spreading section. The spreading section has at least one spreading arm tangential to the device enveloping contour. A system has two bolt-retaining devices of this type and a bolt assembly. A piece of furniture has two adjacent furniture components, wherein a bolt-retaining device of this type is introduced in each furniture component. The bolt-retaining device has a body and an expansion cap with a receiving recess held on an inner side thereof by separators. The body has at least one engaging element on the inner side thereof. The bolt-retaining device ensures a definite position of the introduced shaped bolt or a bolt assembly.

### TECHNICAL FIELD

The disclosure relates to a bolt-retaining device, to a system having two bolt-retaining devices and a bolt assembly, and to a piece of furniture having adjacent furniture components which are connected by the system including bolt-retaining devices in each furniture component.

### BACKGROUND

A bolt-retaining device is known from DE 10 2010 051 372 Al. The shaped bolt has an annular groove, with which it latches in the retaining device, and a cylindrical region for radially pressing a plurality of spreading arms. When setting the shaped bolt, the bolt-retaining device is repeatedly loaded and unloaded, so that the shaped bolt can be mounted incorrectly.

The present disclosure is based on the task to develop a bolt-retaining device, which ensures a defined position of the inserted shaped bolt or of a bolt assembly.

### SUMMARY

This task is accomplished with the features of the main claim. For this purpose, the bolt-retaining device has a body and an expansion cap with an expansion cap enveloping contour formed on the inner side thereof by means of separators. The expansion cap comprises a receiving recess delimited by means of a cover in an insertion direction oriented from the retaining section in the direction of the spreading section. The nominal diameter of the bolt-retaining device, reduced by twice the wall thickness of the spreading section, is smaller than the outer diameter of the expansion cap enveloping contour. The body has at least one engaging element on its inner side. The longitudinally oriented length of the bolt-retaining device, reduced by the length of the expansion cap, is greater than the distance of a retaining surface of the engaging element oriented in the insertion direction from an insertion opening of the bolt-retaining device.

The respective spreading regions are oriented in opposite directions in the system having two bolt-retaining devices. The bolt assembly or the shaped bolt has a centrally arranged latching shaped part. The bolt assembly or the shaped bolt can be inserted and fixed in both bolt-retaining devices to form a connection system.

The piece of furniture is formed such that the furniture components are connected by means of such a system with a bolt assembly or shaped bolt latched on both sides.

The bolt-retaining device has a body and an expansion cap formed on an inner side thereof. With the, for example, tool-free insertion into a recess of a furniture component, the bolt-retaining device is deformed in the radial direction, so that it is force-fittingly and/or form-fittingly retained in the, for example, cylindrical recess. When assembling the piece of furniture, the furniture components are joined by means of a bolt assembly or a shaped bolt which is inserted and latched in two bolt-retaining devices of the adjacent furniture components. When inserting the bolt assembly or the shaped bolt, the expansion cap is sheared off the body and shifted relative to it in the insertion direction. In this case, a spread region is widened, wherein the insertion force increases. Just before reaching the latched end position, engaging elements and/or a latching shaped part are elastically deformed with further increase in the required assembly force. When latching, the latching shaped part of the bolt assembly or the shaped bolt engages, when recovering, behind an engaging element of the bolt-retaining device. The bolt assembly or shaped bolt is pulled relative to the bolt-retaining device in its secure, inseparable end position. The sudden release during recovery can give an acoustic and/or haptic signal for the correct latching of the bolt assembly or of the shaped bolt.

Further details of the invention will become apparent from the dependent claims and the following description of schematically illustrated embodiments.

### BRIEF DESCRIPTION OF THE DRAWINGS

FIG. 1: Isometric view of a bolt-retaining device;

FIG. 2: Isometric sectional view of the bolt-retaining device of FIG. 1 opposite to the insertion direction;

FIG. 3: Isometric sectional view of the bolt-retaining device of FIG. 1;

FIG. 4: Bolt assembly;

FIG. 5: Bolt-retaining device with bolt assembly;

FIG. 6: Bolt-retaining device inserted into furniture component with a partially inserted bolt assembly;

FIG. 7: Bolt-retaining device with latched bolt assembly inserted into furniture component;

FIG. 8: Piece of furniture with connection assembly;

FIG. 9: Bolt-retaining device with pull-in protection;

FIG. 10: Bolt assembly for use with the bolt-retaining device of FIG. 9;

FIG. 11: Bolt-retaining device according to FIG. 9 with secured latched bolt assembly inserted into furniture component;

FIG. 12: Bolt-retaining device with pull-out protection;

FIG. 13: Bolt assembly for use with the bolt-retaining device according to FIG. 12;

FIG. 14: Piece of furniture having a connection assembly consisting of two bolt-retaining devices according to FIG. 12 and a bolt assembly according to FIG. 13.

### DETAILED DESCRIPTION

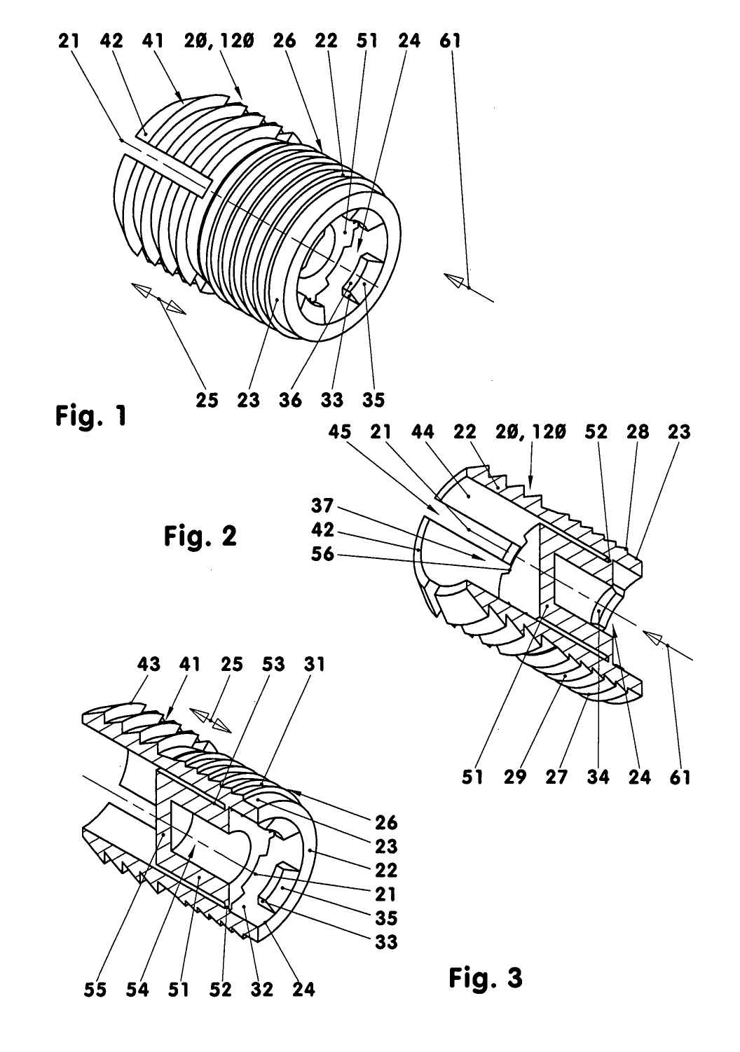

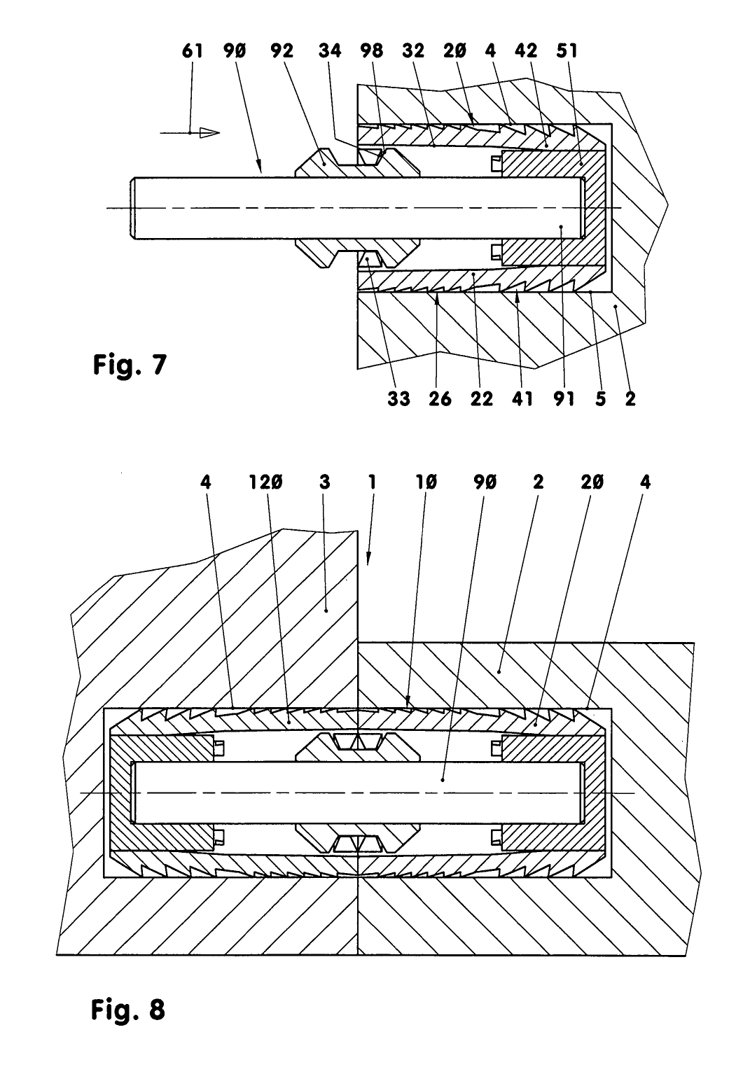

FIGS. 1 to 3 show a bolt-retaining device (20) in the initial state. Bolt-retaining devices (20) of this type are used, for example, to arrange a bolt assembly (90) or a shaped bolt, for example, of the type of a connecting bolt, in a fixed position in a furniture component (2, 3), see FIG. 7. For example, a further furniture component (3, 2) having a second bolt-retaining device (120) can then be attached at the free end of this bolt assembly (90), see FIG. 8.

The bolt-retaining device (20) has a cylindrical enveloping contour. In this case, the enveloping contour is the contour which is tangent to the points of the bolt-retaining device (20) which are furthest away from the geometric center line (21). The center line (21) in this case is oriented in the longitudinal direction (25) of the bolt-retaining device (20). The bolt-retaining device (20) has a body (22) and an expansion cap (51) arranged in this body. The expansion cap (51) is connected to the body (22) in FIGS. 1-3 and 5 by means of support webs (52). In this embodiment, the two parts (22, 51) formed integrally with each other are made of the same thermoplastic material, for example, polyamide, polyoxymethylene (POM), etc. It is also conceivable to use different materials for individual regions of the bolt-retaining device (20).

The body (22) has a guide section (23), a retaining section (26) and a spreading section (41). These three sections (23, 26, 41) are arranged one behind the other in the longitudinal direction (25), wherein an insertion opening (24) is arranged in the region of the guide section (23). The geometric center line of the insertion opening (24) coincides with the center line (21) of the bolt-retaining device (20).

The guide section (23) is formed cylindrical. It has a constant outer diameter over its length, which diameter corresponds to the nominal diameter of the bolt-retaining device (20) in the embodiment. The nominal diameter of the bolt-retaining device (20) shown in FIGS. 1-8 is 8 millimeters in a plane normal to the longitudinal direction (25). The length of the bolt-retaining device (20) is, for example, one and a half times the nominal diameter.

The retaining section (26) adjacent to the guide section (23) in the insertion direction (61) has a saw-toothed shaped outer surface (27) in the longitudinal section. Each of the ring-shaped saw teeth (28) is delimited by a conical surface shaped sliding flank (29) and a, for example, retaining flank (31) oriented normal to the longitudinal direction (25). The retaining flank (31) points, in this case, counter to the bolt insertion direction (61). The diameter of the cylindrically shaped enveloping surface of the retaining section (26) in the embodiment is 7% greater than the nominal diameter of the bolt-retaining device (20). The length of the retaining section (26) is half of the nominal diameter in the embodiment.

The spreading section (41) adjoins the retaining section (26) in the insertion direction (61). Its length is, for example, 62% of the nominal diameter. The spreading section (41) has, for example, four spreading arms (42) which cantilever freely in the insertion direction (61). In an end view of the bolt-retaining device (20), they each cover a segment of 77 degrees. In each case, a gap (45) having a width of, for example, two millimeters, is between the individual spreading arms (42). The individual spreading arm (42) has a sawtooth-shaped outer surface (43) which is oriented like the outer surface (27) of the retaining section (26). In the initial state, the outer surfaces (43) of all spreading arms (42) are tangential to the enveloping contour of the bolt-retaining device (20).

The inner enveloping surface of the spreading section (41) tangential to the spreading arm inner surfaces (44) is aligned with the inner side (32) of the body (22). The diameter of these, for example, inner cylindrical surfaces is, for example, 77% of the nominal diameter. The wall thickness of the individual spreading arm (42), this being the distance between the enveloping contour of the bolt-retaining device (20) to the inner wall of the spreading section (41), is 17.5% of the nominal diameter in the embodiment.

Four engaging elements (33) are arranged along a circumference line on the inner side (32) in the region of the insertion opening (24) in the embodiment. They have a common center transverse plane, which is arranged normal to the longitudinal direction (25) of the bolt-retaining device (20). The engaging elements (33) thus form segments of an inner ring. Each of the regularly arranged segments covers, for example, an angle of 45 degrees. The individual engaging elements (33) have a constant, prism-shaped cross-section. The tapering wedge of the prism has an imaginary point angle of 45 degrees in the direction of the center line (21). In the embodiment, the retaining surfaces (34) of the engaging elements (33) pointing in the direction of the spreading section (41) enclose an angle of 20 degrees with a normal plane to the longitudinal direction (25). This angle can be between 0 degrees and 25 degrees. The insertion surfaces (35) of the engaging elements (33) pointing in the direction of the insertion opening (24) enclose an angle between 15 degrees and 75 degrees with the longitudinal direction (25). This angle is 65 degrees in the embodiment of FIGS. 1-8. The inner flanks (36) of the engaging elements (33) delimit an imaginary inner diameter of 57% of the nominal diameter in the embodiment.

On the inner side (32), the expansion cap (51) is further attached by means of, for example, four separators (52). These separators (52) are formed as shearing webs (52). They are cuboid-shaped, wherein each edge length is between one twentieth and one twenty-fifth of the nominal diameter. The distance of the expansion cap (51) from the inner side (32) of the body (22) in this case corresponds, for example, to the shortest edge length of the cuboid.

The expansion cap (51) is offset from the engaging elements (33) so that the engaging elements (33) sit between the expansion cap (51) and the insertion opening (24). The engaging elements (33) intersect a plane oriented normal to the longitudinal direction (25), which is offset to the separators (52) counter to the insertion direction (61). The length of the bolt-retaining device (20, 120) oriented in the longitudinal direction (25), reduced by the length of the expansion cap (51), is greater than the distance of the retaining surface (34) of the insertion opening (24) pointing in the insertion direction (61).

The expansion cap (51) is cup-shaped in the embodiment. It has a receiving depression (54) pointing counter to the insertion direction (61) and a cover (55) closing the receiving depression (54) in the insertion direction (61). The diameter of the cylindrically shaped receiving depression (54) is, for example, 37.5% of the nominal diameter. Recesses (56) are arranged between the, for example, four cover surface sections (53), for example, oriented parallel to the longitudinal direction (25). The diameter of the expansion cap enveloping contour is 70% of the nominal diameter of the bolt-retaining device (20). The expansion cap enveloping contour is the cylindrical contour having a circular cross-section, which is tangential to the cover surface sections (53) of the expansion cap (51).

The recesses (56) are aligned with the engaging elements (33) and with the gaps (45) between the spreading arms (42). Thus, the cover surface sections (53) lie in the same sector of the enveloping contour of the bolt-retaining device (20) as the spreading arms (42). The length of the expansion cap (51) in the longitudinal direction (25) corresponds to 62.5% of the nominal diameter in the embodiment.

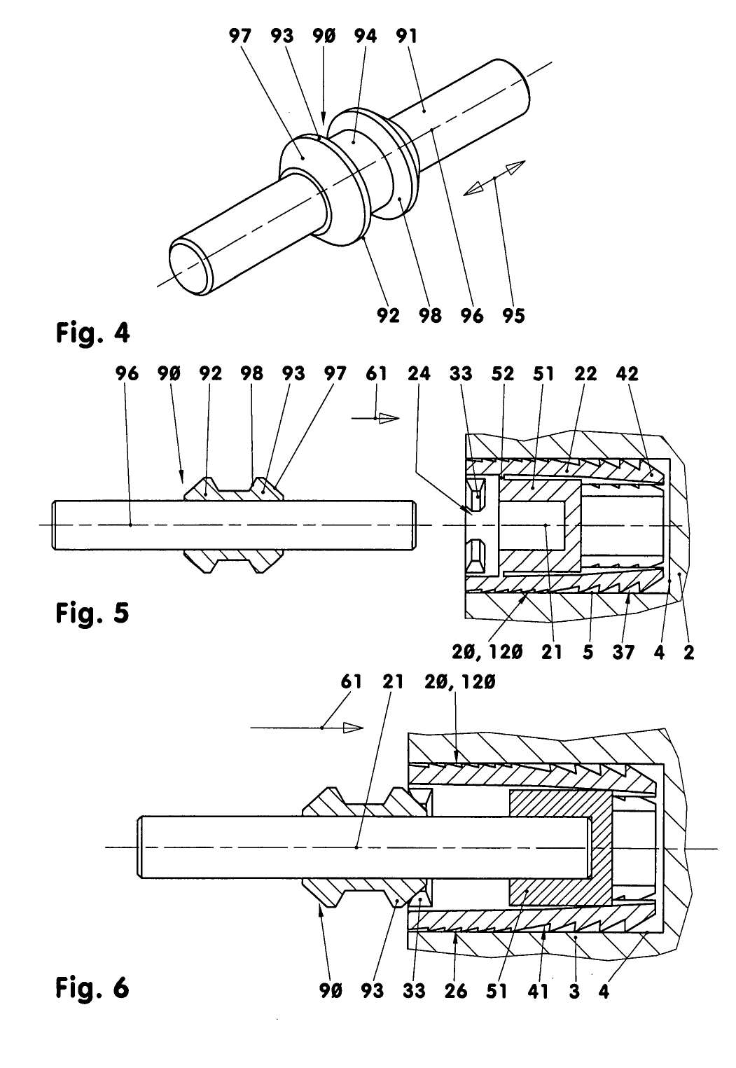

FIGS. 4 and 5 show a bolt assembly (90). It consists of a bolt (91) and a latching shaped part (92). The bolt (91) is cylindrical and free of notches. Its diameter is, for example, 37.5% of the nominal diameter and its length corresponds to 2.75 times the nominal diameter in the embodiment. The bolt (91) is made of a steel material in the embodiment. However, it can also be made of plastic.

The latching shaped part (92) is firmly connected to the bolt (91). For example, it is pressed or molded onto this. It consists, for example, of an elastically deformable thermoplastic material and sits in the bolt assembly longitudinal direction (95) centered on the bolt (91). Its length is, for example, 75% of the nominal diameter of the bolt-retaining device (20). The maximum diameter of the latching shaped part (92) is 72.5% of the nominal diameter in the embodiment. The latching shaped part (92) is rotationally symmetrical about the center line (96) of the bolt assembly (90) and axisymmetric to a center transverse plane oriented normal to the center line (96).

In the illustrations of FIGS. 4 and 5, the latching shaped part (92) has two circumferential latching rings (93) with a prism-shaped longitudinal section. Each of these latching rings (93) has in the direction of the center line (96) outer, frustoconical insertion surfaces (97) and two inner, also frustoconical-shaped engaging surfaces (98). The tip angle of the insertion cone (97) is in each case, for example, 85 degrees, wherein the cone tip is in each case outside of the latching shaped part (92) on the center line (96).

The two engaging cones (98) each have a point angle of, for example, 120 degrees. The imaginary cone tip lies in each case on the center line (96) near the point of intersection with said center transverse plane.

The latching shaped part (92) has, for example, a cylindrically shaped collar section (94) between the engaging surfaces (98). The diameter of this collar section (94) is 50% of the nominal diameter of the bolt-retaining device (20) in the embodiment. The length of the collar section (94) shown in FIGS. 4 and 5, for example, corresponds to the nominal diameter.

The bolt assembly (90) may also be formed such that the bolt (91) and the latching shaped part (92) are produced, for example, in a common injection molding process. The latching shaped part (92) is then formed on the bolt (91). Here, the bolt (91) and the latching shaped part (92) can consist of the same or different materials. In the latter case, the bolt assembly (90) can be produced, for example, as a shaped bolt, for example, in a two-component process. However, it is also conceivable to produce the entire bolt assembly (90) or the shaped bolt from a metallic material, for example, steel.

For example, prior to the assembly of a piece of furniture (1), the bolt-retaining device (20, 120) is already inserted into a blind hole (4) of a furniture component (2, 3) at the furniture manufacturer, see FIG. 5. This can be done without or with a tool. The diameter of the blind hole (4) is, for example, 2.5% larger than the nominal diameter of the bolt-retaining device (20, 120). The depth of the blind hole (4) corresponds to at least the length of the bolt-retaining device (20, 120) in the embodiment. For example, identical blind holes (4) are introduced into all furniture components (2, 3), in which identically formed bolt-retaining devices (20, 120) are inserted. The minimum plate thickness of the furniture component (2, 3) is, for example, 87.5% larger than the nominal diameter of the bolt-retaining device (20, 120).

FIG. 5 shows the furniture component (2, 3) with the bolt-retaining device (20) inserted therein. Both the retaining section (26) and the spreading section (41) are elastically deformed so that the sliding flanks (29) rest against the blind hole (4). The spreading arms (42) are deflected in the direction of the interior (37) of the bolt-retaining device (20). The expansion cap (51) is fixed unchanged in the body (22) of the bolt-retaining device (20).

The bolt assembly (90) can now be inserted into the bolt-retaining device (20) in the bolt insertion direction (61). To this end, the bolt assembly (90) is aligned relative to the bolt-retaining device (20) so that the center line (96) of the bolt assembly (90) coincides with the center line (21) of the bolt-retaining device (20).

With machine or manual insertion of the bolt assembly (90) into the bolt-retaining device (20), the bolt (91) is pushed through the insertion opening (24) into the receiving recess (54) of the expansion cap (51). At first, no resistance is noticeable. The bolt (91) strikes the cover (55) of the expansion cap (51). Upon further insertion of the bolt assembly (90), the expansion cap (51) is separated from the body (22). For example, the separators (52) are sheared off. The bolt assembly (90) now with further insertion shifts the expansion cap (51) relative to the body (22) in the insertion direction (61), see FIG. 6.

The insertion cone (97) of the bolt assembly (90) located in the insertion direction (61) on the front abuts the insertion chamfers (35) of the engaging elements (33) with further insertion. The engaging elements (33) and/or the latching shaped part (92) are elastically deformed. The ring (93) located in the insertion direction (61) on the front is shifted in the insertion direction (61) until the engaging cone (98) abruptly engages behind the engaging elements (33), see FIG. 7. With, noticeable and audible, resetting of the engaging elements (33) and/or the latching ring (93), the engaging cone (98) and the retaining surfaces (34) slide along each other. The bolt assembly (90) is pulled relative to the bolt-retaining device (20) in the end position. The engaging cone (98) of the bolt assembly (90) now bears against the retaining surfaces (34) of the engaging elements (33). The bolt assembly (90) is inseparably secured against being pulled out. The bolt-retaining device (20) is pre-stressed in the longitudinal direction (25).

When inserting the bolt assembly (90), the expansion cap (51) contacts the spreading arms (42) of the body (22). The spreading arms (42) are pressed radially outward and press against the wall (5) of the blind hole (4). The spreading arms (42) are deformed in this case. The bolt-retaining device (20) is thus retained securely and inseparably in the blind hole (4).

FIG. 8 shows a piece of furniture (1) having two furniture components (2, 3) connected to each other. In each furniture component (2, 3), a bolt-retaining device (20, 120) is inserted in a blind hole (4), which bolt-retaining device is constructed as the bolt-retaining device (20, 120) described in FIGS. 1-7. The bolt assembly (90) is inserted in the system with the two bolt-retaining devices (20, 120), for example, by the end user assembling the piece of furniture (1). It can initially be inserted on one side into the bolt-retaining device (20, 120) of a first furniture component (2, 3). Then, the second furniture component (3, 2) is set so that the center lines (21) of both bolt-retaining devices (20, 120) are aligned with each other. The bolt assembly (90) can also initially be inserted loosely in both furniture components (2, 3). When pressing together both furniture components (2, 3), the bolt assembly (90) latches in both bolt-retaining devices (20, 120), whereby the furniture components (2, 3) are pulled to the mutual gap-free fit. The two furniture components (2, 3) are now inseparably connected to each other by means of a connection system (10). After assembly, both the bolt-retaining devices (20, 120) and the bolt assembly (90) are invisible. The assembly of a furniture body can thus be accomplished without tools quickly and easily.

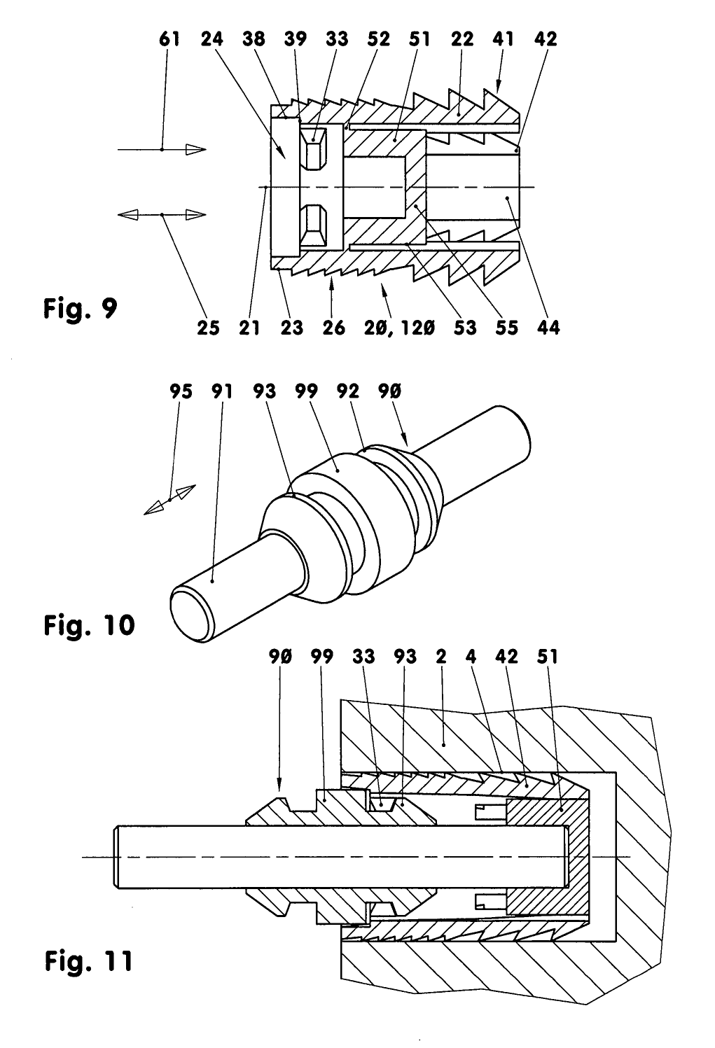

FIG. 9 shows a further embodiment of a bolt-retaining device (20, 120). The diameter of the enveloping contour of the bolt-retaining device (20, 120), which in this case also corresponds to the diameter of the enveloping contour of the spreading section (41), is in this embodiment 20% greater than the nominal diameter of the bolt-retaining device (20, 120). The diameter of the enveloping contour of the retaining section (26) corresponds to the diameter of the enveloping contour of the retaining section (26) of the first embodiment.

The insertion opening (24) has a widening (38), the diameter of which is 85% of the nominal diameter. The depth of the widening (38) in the longitudinal direction (25) is, for example, 17% of the nominal diameter. The contact surface (39) of the widening (38) is oriented normal to the longitudinal direction (25). The engaging elements (33) are arranged between the widening (38) and the expansion cap (51). The diameter of expansion cap enveloping contour and the inner diameter of the body (22) in this embodiment have the same dimensions as the corresponding dimensions of the first embodiment.

FIG. 10 shows a bolt assembly (90) for the bolt-retaining device (20) shown in FIG. 9. It comprises a bolt (91) having a latching shaped part (92) molded onto it. The materials of the components of the bolt assembly (90) correspond to the materials of the corresponding components of the bolt assembly (90) shown in FIGS. 4 and 5.

The latching shaped part (92) has two latching rings (93), for example, having an insertion cone (97) with a smaller cone angle than the latching rings (93) of the first embodiment. A stop collar (99) is arranged centrally between the two latching rings (93). The diameter of this stop collar (99) is, for example, 81% of the nominal diameter, its length oriented in the bolt assembly longitudinal direction (95) being 30% of the nominal diameter.

The bolt assembly (90) is inserted in the bolt-retaining device (20) as described in connection with the first embodiment. After the shearing of the separators (52), the bolt (91) shifts the expansion cap (51), which presses the spreading region (41) to the receiving recess (4) of the furniture component (2, 3), see FIG. 11. The bolt assembly (90) is retained as soon as the engaging cone (98) engages behind the engaging elements (33). In addition, the stop collar (99) is located in the widening (38). It thus prevents excessive insertion of the bolt assembly (90) into the bolt-retaining device (20). In addition, the stop collar (99) centers the bolt assembly (90) relative to the bolt-retaining device (20). This press-in securing thus facilitates the subsequent assembly of the second furniture component (3, 2). The bolt-retaining device (20) shown in FIG. 9 can also be combined with the bolt assembly (90) shown in FIG. 4.

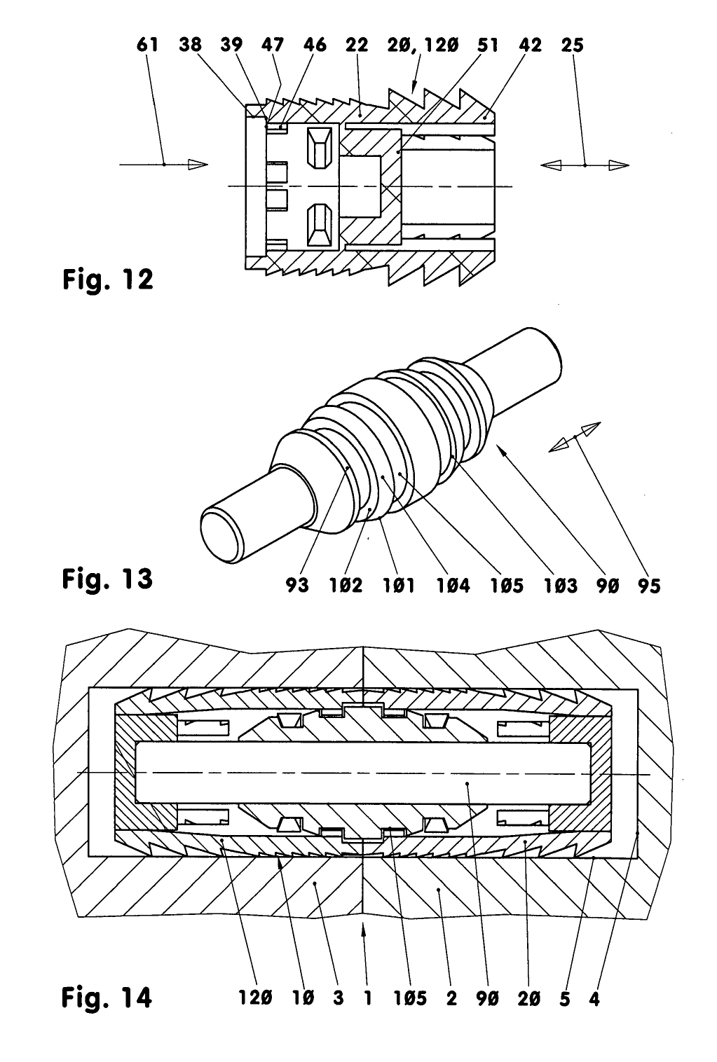

FIG. 12 shows a further example of a bolt-retaining device (20, 120). This bolt-retaining device (20, 120) has the same length as the bolt-retaining devices (20) described in connection with the preceding embodiments. Also, the diameter of the expansion cap enveloping contour and the inner diameter of the body (22) correspond to the corresponding dimensions of the other embodiments.

The diameter of the enveloping contour of the bolt-retaining device (20) is 20% larger than the nominal diameter in this embodiment. The diameter of the retaining section (26) corresponds to the diameter of the retaining sections (26) of the other embodiments.

A widening (38) is formed at the insertion opening (24), which widening is formed as the widening (38) shown in FIG. 9. Retaining blocks (46) are arranged on the inner side (32) between the widening (38) and the engaging elements (33). In this case, the end faces (47) of the retaining blocks (46) oriented counter to the insertion direction (61) are flush with the contact surface (39) of the widening (38). They have a rectangular area in the longitudinal section shown in FIG. 12. The circular area delimited by the retaining blocks (46) and oriented normal to the center line (21) has a larger diameter than the circular area lying parallel thereto and delimited by the engaging elements (33). In the embodiment, the diameter of the area delimited by the retaining blocks (46) is 70% of the nominal diameter.

FIG. 13 shows a bolt assembly (90) for insertion in the bolt-retaining device (20, 120) of FIG. 12. The cylindrical bolt (91) is formed as described in connection with the other embodiments. The latching shaped part (92) has latching rings (93), a stop collar (99) and two retaining rings (101). The latching rings (93) have an insertion cone (97) having a point angle of 67 degrees in this embodiment. The respective engaging cone (98) has an imaginary point angle of 140 degrees. The outer diameter of the latching rings (93) is smaller than the diameter of a circle delimited by the inner surfaces of the retaining blocks (46).

The individual retaining ring (101) is in each case arranged between the latching ring (93) and the stop collar (99). It has two end faces (102, 103) parallel to each other, one of which points in the direction of the latching ring (93) and the other in the direction of the stop collar (99). The two end faces (102, 103) are connected, for example, by means of a frusto-conical sliding surface (104). The imaginary point angle of this sliding surface (104) is 40 degrees in the embodiment. This imaginary tip is located on the center line (96) of the bolt assembly (90) outside of the latch shaped part (92). The outer diameter of the retaining ring (101) is greater than the diameter of a circle delimited by the engaging elements (33) and smaller than the diameter of the inner side (32) of the body (22). Said diameters are respectively in planes oriented normal to the longitudinal directions (25, 95).

The bolt assembly (90) is inserted in the bolt-retaining device (20) as described in connection with the other embodiments. Here, the bolt assembly (90) shifts the expansion cap (51) after separating the shearing webs (52) in the insertion direction (61) relative to the body (22). The expansion cap (51) presses the spreading arms (42) against the wall (5) of the blind hole (4). The bolt-retaining device (20, 120) is thus securely retained. During the insertion of the bolt assembly (90), the sliding surface (104) slides along the retaining blocks (46) until the rear end face (103) in the insertion direction (61) latches behind the retaining blocks (46). The rear end face (103) and the stop collar (99) thus delimit a blocking recess (105). The bolt assembly (90) is additionally secured in the bolt-retaining device (20, 120) by means of this pull-out protection. The bolt assemblies (90) shown in FIGS. 4 and 10 can also be inserted in the bolt-retaining device (20, 120) according to FIG. 12. For example, after inserting a bolt-retaining device (20, 120) into a second furniture component (3, 2), the system can be joined with two bolt-retaining devices (20) and a bolt assembly (90). After joining, it forms a connection system (10) for connecting both furniture components (2, 3).

FIG. 14 shows two furniture components (2, 3) which are connected to each other by means of a connection system (10). The connection system (10) shown here comprises two bolt-retaining devices (20, 120) according to FIG. 12, which are each inserted into one of the furniture components (2, 3). A bolt assembly (90) according to FIG. 13 is latched in both, for example, identical bolt-retaining devices (20, 120) such that one end of the bolt assembly (90) is retained securely in the first and the other end in the second bolt-retaining device (20, 120). Also in this embodiment, the bolt-retaining devices (20, 120) are already inserted in the furniture components (2, 3) by the furniture manufacturer. The end customer, who assembles the furniture (1), then sets the bolt assembly (90) in the bolt-retaining devices (20) and, for example, joins the two furniture components (2, 3) without tools.

Combinations of the individual embodiments are also conceivable.

### LIST OF REFERENCE NUMBERS

1 piece of furniture
2 furniture component
3 furniture component
4 blind hole, receiving recess
5 wall of (4)
10 connection system
20 bolt-retaining device
21 center line
22 body, dowel part
23 guide section
24 insertion opening
25 longitudinal direction
26 retaining section
27 outer surface
28 saw teeth
29 sliding flank
31 retaining flank
32 inner side
33 engaging elements
34 retaining surface
35 insertion surface, insertion chamfers
36 inner flanks
37 interior
38 widening
39 contact surface
41 spreading section
42 spreading arms
43 outer surface
44 spreading arm inner surfaces
45 gap
46 retaining blocks
47 end face
51 expansion cap
52 support webs, shearing webs, separators
53 cover surface sections
54 receiving depression, receiving recess
55 cover
56 recesses
61 insertion direction
90 bolt assembly
91 bolt
92 latching shaped part
93 rings, prismatic, latching rings
94 collar section
95 bolt assembly longitudinal direction
96 centerline of (90)
97 insertion surfaces, insertion cone
98 engaging surfaces, engaging cone
99 stop collar
101 retaining rings
102 end face
103 end face
104 sliding surface
105 blocking recess
120 bolt-retaining device

1.-9. (canceled)

10. A bolt-retaining device, having a cylindrical device enveloping contour, a diameter of which is larger than a nominal diameter of the bolt-retaining device, comprising:
at least one retaining section;
a spreading section offset to the at least one retaining section in a longitudinal direction of the bolt-retaining device, the spreading section having at least one spreading arm tangential to the cylindrical device enveloping contour;
a body;
an expansion cap having an expansion cap enveloping contour, the expansion cap being held on an inner side of the body by separators,
wherein the expansion cap comprises a receiving recess delimited by a cover in an insertion direction oriented from the at least one retaining section towards the spreading section,
wherein the nominal diameter of the bolt-retaining device, reduced by twice a wall thickness of the spreading section, is smaller than an outer diameter of the expansion cap enveloping contour,
wherein the body has at least one engaging element on the inner side, and
wherein a longitudinal length of the bolt-retaining device, reduced by a length of the expansion cap, is greater than a distance of a retaining surface of the engaging element oriented in the insertion direction from an insertion opening the bolt-retaining device.

11. The bolt-retaining device according to claim 10, wherein the diameter of the cylindrical device enveloping contour is between 10% and 25% greater than the nominal diameter of the bolt-retaining device.

12. The bolt-retaining device according to claim 10, wherein the inner side of the body is aligned with a spreading arm inner surface of the at least one spreading arm.

13. The bolt-retaining device according to claim 10, wherein the at least one engaging element is elastically deformable.

14. The bolt-retaining device according to claim 10, wherein the retaining surface of the engaging element oriented towards the spreading section encloses an angle which is smaller than 25 degrees with a normal plane to the longitudinal direction.

15. A system having two bolt-retaining devices according to claim 10 and a bolt assembly or a shaped bolt,
wherein the respective spreading sections are oriented in opposite directions,
wherein the bolt assembly or the shaped bolt has a centrally arranged latching shaped part, and
wherein the bolt assembly or the shaped bolt can be inserted and fixed in both bolt-retaining devices to form a connection system.

16. The system according to claim 15, wherein the latching shaped part has a stop collar, an outer diameter of which is greater than a diameter of the inner side of the body.

17. The system according to claim 15,
wherein retaining blocks are arranged on the inner side and
wherein the latching shaped part has a blocking recess.

18. A piece of furniture having two adjacent furniture components,
wherein a bolt-retaining device is inserted in each furniture component, and
wherein the furniture components are connected with a latched bolt assembly or a shaped bolt on both sides by a system according to claim 16.
